(19) United States
(12) Patent Application Publication
(10) Pub. No.: US 2012/0227081 A1
(43) Pub. Date: Sep. 6, 2012

(54) WEB USER AGENT BASED INSPECTION

(75) Inventors: Peter James Huitsing, Severn, MD (US); Andre Derek Protas, Austin, TX (US)

(73) Assignee: Ready Speak, LLC, Joplin, MO (US)

(21) Appl. No.: 13/408,114

(22) Filed: Feb. 29, 2012

Related U.S. Application Data
(60) Provisional application No. 61/447,819, filed on Mar. 1, 2011.

(51) Int. Cl. G06F 21/00

(52) U.S. Cl. 726/1

(57) ABSTRACT

Among other things, one or more systems and/or techniques for web user agent based inspection are provided herein. In particular, content provided by a user (e.g., to a server) may be processed using one or more web user agents (e.g., web browsers). The processing may involve opening and/or interpreting content provided by the user with one or more web user agents. Based on the processing, one or more profiles for the website may be created (e.g., for respective web user agents). Respective profiles may be evaluated based on one or more policies (e.g., for respective web user agents), and a determination may be made (e.g., to perform and/or not perform an action) based on the evaluation (e.g., allow a comment to be posted (or not) to a blog).

### RELATED APPLICATION

This application corresponds to U.S. Application No. 61/447,819, filed on Mar. 1, 2011, entitled “METHOD FOR TESTING WEBSITE CODE AGAINST AN ACCEPTABLE WEBSITE CODE POLICY,” at least some of which may be incorporated herein.

### BACKGROUND

A website may be accessed by one or more users (e.g., to obtain information). In one example, a website may be accessed by a user via a network. In another example, a website may be accessed by a user via the Internet. A website may be configured to allow users to provide content to the website. The website may be configured to share the content provided by users with other users of the website. Unfortunately, a malicious user may manipulate the website by providing malicious content to the website, which may then spread the malicious content to one or more other users that access the website.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for web user agent based inspection are disclosed herein. It may be appreciated that a web user agent may comprise a web browser. A web user agent may, for example, be used to browse content and/or information (e.g., accessed via a network, the Internet, etc.). Content browsed by a web user agent may comprise one or more websites, which may comprise data written in one or more of a variety of languages, such as HyperText Markup Language (HTML), JavaScript, Cascading Style Sheets (CSS), etc.

In one example of web user agent based inspection, code may be received. The code may comprise content provided by a user. The user may have provided the content to a website (e.g., associated with a system configured to perform web user agent based inspection). In one example, the content may comprise a comment of the user (e.g., associated with information comprised in the website). In another example, the content may comprise text, one or more links, one or more images and/or code configured to perform an action.

The received code may be processed using one or more web user agents. In one example, the code may be processed (e.g., opened, executed and/or parsed) by a first web user agent, a second web user agent, and a third web user agent. A first profile may be created based on the processing of the code by the first web user agent, a second profile may be created based on the processing of the code by the second web user agent, and a third profile may be created based on the processing of the code by the third web user agent. The profiles may, for example, indicate how a user accessing the code from respective web user agents would view and/or process the code. It may be appreciated that more or fewer web agents may be used to create additional or fewer profiles.

Respective profiles may be evaluated based on one or more policies. In one example, a first policy may exist for the first web user agent, a second policy may exist for the second web user agent, and a third policy may exist for the third web user agent, etc. The respective policies may, for example, comprise one or more rules. The respective profiles may be evaluated based on (e.g., compared to) one or more policies that correspond to a same web user agent as the respective profiles. For example, the first policy (which corresponds to the first web user agent) may be evaluated based on the first profile (which also corresponds to the first web user agent), the second policy (which corresponds to the second web user agent) may be evaluated based on the second profile (which also corresponds to the second web user agent), and the third policy (which corresponds to the third web user agent) may be evaluated based on the third profile (which also corresponds to the third web user agent), etc.

Based on one or more of the evaluations, a determination may be made as to a course of action to take corresponding to the code. In one example, the determination may correspond to providing or not providing the code to a client. In the example, the determination may be based on whether one or more of the profiles conflict with one or more rules comprised in one or more of the policies.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of web user agent based inspection.

FIG. 2 is a component block diagram illustrating an exemplary system for web user agent based inspection.

FIG. 3 is a flow chart illustrating an exemplary method of web user agent based inspection.

FIG. 4 is a flow chart illustrating an exemplary method of web user agent based inspection.

FIG. 5 is a flow chart illustrating an exemplary method of web user agent based inspection.

FIG. 6 is a flow chart illustrating an exemplary method of web user agent based inspection.

FIG. 7 is a flow chart illustrating an exemplary method of web user agent based inspection.

FIG. 8 is an illustration of an example of a website that may receive code from a user.

FIG. 9 is an illustration of an exemplary computer-readable medium wherein processor-executable instructions configured to embody one or more of the provisions set forth herein may be comprised.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

A server (e.g., one or more operatively inter-associated devices) may provide information and/or content to one or more users that connect to the server via a network (e.g., the Internet). In some instances, a server may comprise a feature enabling one or more users (e.g., that are connected to the server) to provide information and/or content to the server. For example, information provided by a user to the server may be shared, by the server, with other users that connect to the server. In one example, sharing of information may allow for user-to-user interaction, and/or may be an important feature of a service hosted by the server (e.g., a blog, a social networking website, a forum, an email application, etc.). Unfortunately, a malicious user may use the feature to provide to the server, and thereby share with other users, malicious data that may adversely affect one or more of the other users (e.g., by hijacking a user account, providing unsolicited advertisements, etc.).

Accordingly, among other things, one or more systems and/or techniques for web user agent based inspection are provided herein. In particular, content provided by a user (e.g., to a server) may be processed using one or more web user agents (e.g., web browsers). The processing may involve opening and/or interpreting content provided by the user with one or more web user agents. Based on the processing, one or more profiles may be created (e.g., for respective web user agents). Respective profiles may be evaluated based on one or more policies (e.g., for respective web user agents), and an action may be performed (e.g., and/or not performed) based on the evaluation.

In one implementation, web user agent based inspection may be performed at least in part by a client (e.g., accessing a website using a web user agent). For example, a client accessing a website using a web user agent may comprise software (e.g., antivirus and/or security software) that may run (e.g., concurrently) with the web user agent. In another example, a client accessing a website using a web user agent may comprise a web user agent add-on (e.g., a web browser plug-in). In another implementation, web user agent based inspection may be performed at least in part by a server. The server may be associated with a website (e.g., a blog, a social networking website, a forum, an email application, etc.) that enables one or more users to provide content to the website (e.g., which may be used to share the content with other users). In another implementation, web user agent based inspection may be performed at least in part by a server that is not associated with a website that enables one or more users to provide content to the website (e.g., which may be used to share the content with other users). For example, the server may be associated with a third-party security provider. The server may perform web user agent based inspection on content (e.g., a website) provided by a different server, prior to enabling a user to access the content.

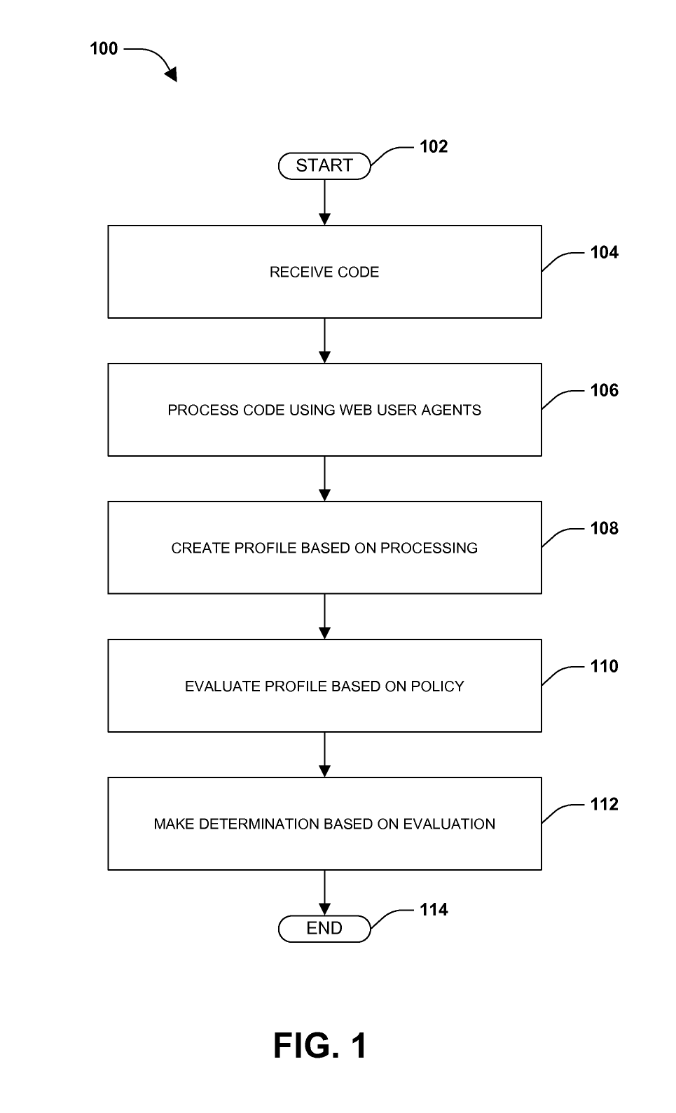

One embodiment of web user agent based inspection is illustrated by an exemplary method 100 in FIG. 1. At 102, the method starts. At 104, code may be received. In one example, the code may be received by a server. The code may, for example, comprise content provided by a user. For example, the code may comprise content provided by a user as a comment to a blog. Alternatively, the code may comprise content provided by a user as a response to a thread on a forum. The server may, for example, be associated with a website (e.g., a blog, a social networking website, a forum, an email application, etc.) that enabled a user to provide at least some of the code. In another example, the code may be received by a user. The user may have received the code by accessing a website (e.g., a blog, a social networking website, a forum, an email application, etc.). The website may have enabled another user to provide at least some of the code (e.g., by posting a new thread on a forum or by posting a comment on a blog).

At 106, the code may be processed using one or more web user agents. In one example, the code (e.g., in its entirety) may be interpreted (e.g., parsed) by one or more web user agents. The one or more web user agents may comprise one or more web browsers. For example, there may be a first web user agent, a second web user agent, and a third web user agent. In the example, the code may be interpreted (e.g., opened) by the first web user agent, by the second web user agent, and by the third web user agent. In another example, there may be three versions of the second web user agent (e.g., that are publicly available and/or privately available to authorized users) (e.g., wherein one of the versions is newer than at least one of the other versions). In the example, the code may be processed by the first web user agent, a first version of the second web user agent, a second version of the second web user agent, a third version of the second web user agent, and the third web user agent. It may appreciated that the code may be processed using any number (e.g., 1, 2, 3, 4, 5 . . . ) of web user agents.

It may be appreciated that in one embodiment, code received and/or processed may depend on a web user agent used to receive and/or process the code. For example, a user accessing a website via a first web user agent may receive and/or process a first version of code associated with the website (e.g., based on a rule of the website indicating that users that access the website with the first web user agent may be provided with the first version of the code). Similarly, a user accessing the website via a second web user agent may receive and/or process a second version of code associated with the website, and a user accessing the website via a third web user agent may receive and/or process a third version of code associated with the website. In a different example, a website may provide one or more versions of code (e.g., associated with the website) for one or more specified web user agents, and a different version of code (e.g., associated with the website) for one or more remaining web user agents (e.g., all web user agents not comprising the one or more specified web user agents).

At 108, one or more profiles may be created based on the processing of the code. Respective profiles may correspond to a particular web user agent. For example, a first profile may correspond to a first web user agent, a second profile may correspond to a second web user agent, and a third profile may correspond to a third web user agent. The one or more profiles may indicate one or more types of content comprised in the code. For example, a profile may indicate that code comprises text. Alternatively, a profile may indicate that code comprises a link (e.g., a hyperlink). Alternatively, a profile may indicate that code comprises an indication of one or more images and/or videos. The one or more images and/or videos may, for example, be externally hosted (e.g., by a server separate from a server configured to receive the code). In another example, a profile may indicate one or more sections of the code. In the example, the profile may indicate types of content comprised in a portion of the code that was submitted by a user. In addition, the profile may indicate types of content comprised in a portion of the code that corresponds to advertising content.

At 110, one or more profiles may be evaluated based on one or more policies. Respective policies may, for example, comprise rules, and may correspond to a particular web user agent. For example, a first policy may comprise rules for a first web user agent, a second policy may comprise rules for a second web user agent, and a third policy may comprise rules for a third web user agent. In the example, the first policy may indicate a maximum and/or minimum amount of text permitted. The second policy may indicate a maximum and/or minimum number of links permitted. The third policy may indicate a type of coding language that is not permitted. One or more profiles may be evaluated based on (e.g., a comparison with) one or more policies. In another example, respective profiles may be compared to respective policies corresponding to a same web user agent. For example, the first policy (e.g., which corresponds to the first web user agent) may be compared to a first profile (e.g., which also corresponds to the first web user agent), the second policy (e.g., which corresponds to the second web user agent) may be compared to a second profile (e.g., which also corresponds to the second web user agent), and the third policy (e.g., which corresponds to the third web user agent) may be compared to a third profile (e.g., which also corresponds to the third web user agent). It may be appreciated that an evaluation of a profile may be based on a parsing of code (e.g., a parse tree) and/or a search for code (e.g., a function) that is restricted.

It may be appreciated that a policy may comprise one or more other rules. In one example, a rule may pertain to (e.g., restrict) one or more tags. In the example, the rule may prohibit IFrame tags (e.g., in one or more pages, and/or in one or more parts of a page), or may restrict a number of IFrame tags (e.g., so that no more than two IFrame tags are permitted). In another example, a rule may restrict script tags (e.g., by prohibiting script tags, and/or restricting a number of script tags (e.g., so that no more than four script tags are permitted)). A rule may also pertain to (e.g., restrict) elements (e.g., JavaScript elements) and/or attributes. In one example, a rule may prohibit one or more attributes comprising onMouseOver and/or onClick. In another example, a rule may restrict a number of attributes comprising onMouseOver and/or onClick (e.g., so that no more than six attributes comprising onMouseOver and/or onClick are permitted). In another example, a rule may restrict a reference (e.g., script, text, link, image, video, etc.) to one or more locations (e.g., based on a list of prohibited locations and/or a list of allowed locations). It may be appreciated that in some implementations, tags, elements, attributes and/or references restricted in one or more rules may be based on one or more blacklists (e.g., that may specify restricted content) and/or one or more whitelists (e.g., that may specify allowed content).

In one example, a rule may pertain to (e.g., restrict) a size and/or amount of text, an image, a video, etc. In the example, a rule may specify a minimum and/or maximum permissible size of text (e.g., font size). In another example, a rule may pertain to (e.g., restrict) one or more attributes that may induce a programming language (e.g., JavaScript). In the example, an attribute may comprise a JavaScript-inducing attribute, and/or may be associated with (e.g., added to) a tag (e.g., an anchor tag) and/or element. In another example, a rule may restrict an existence and/or count of a script, behavior of a web user agent (e.g., when executing website code), and/or a form (e.g., which may also be referred to as a structure), size and/or content of a tree (e.g., a Document Object Model tree and/or a JavaScript parse tree). In another example, a tree (e.g., a JavaScript parse tree) may be searched to look for restricted code (e.g., function calls). It may be appreciated that a rule may specify a set of one or more attributes and/or features, wherein attributes and/or features not comprised in the set of attributes may be restricted (e.g., as in a whitelist).

At 112, a determination may be made based on the evaluation. In one example, if, based on an evaluation, a determination is made that a profile conflicts with one or more policies corresponding to a same web user agent as the profile, then a first action may be performed. In the example, the first action may be to not provide the code to a client. In another example, if, based on an evaluation, a determination is made that a profile does not conflict with one or more policies corresponding to a same web user agent as the profile, then a second action may be performed. In the example, the second action may be to provide the code to a client.

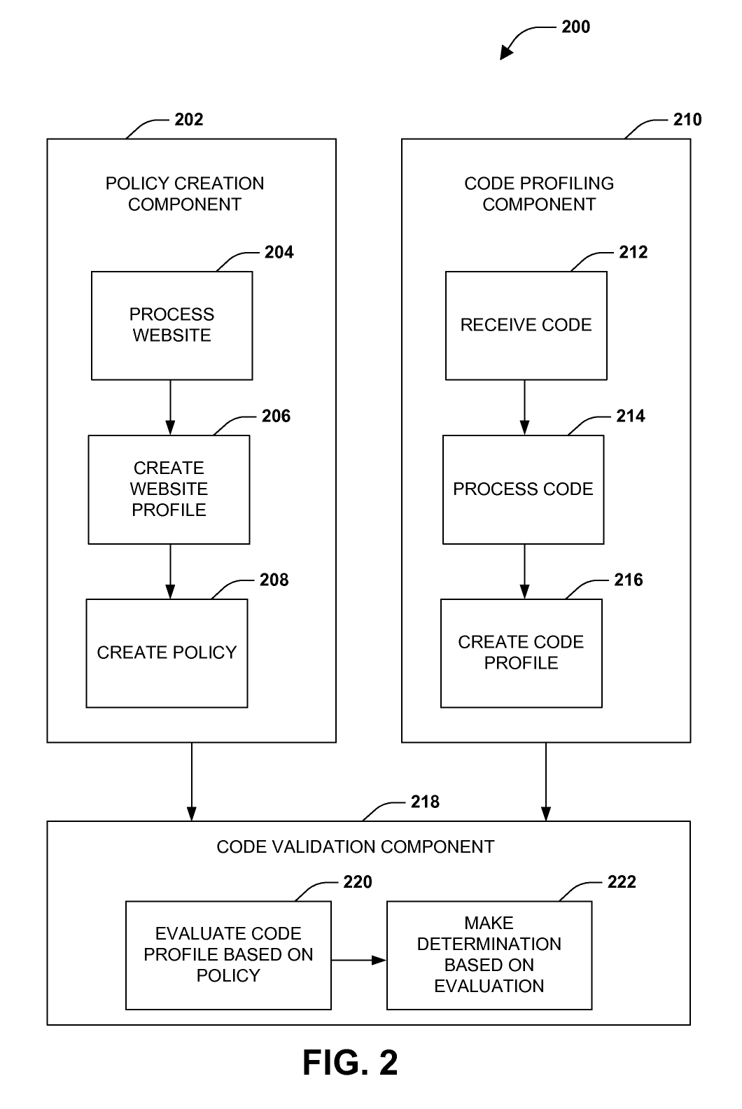

FIG. 2 illustrates an example of a system 200 configured for web user agent based inspection. The system 200 may comprise a policy creation component 202. The policy creation component 202 may be configured to process a website 204. Processing a website may comprise opening a website using one or more web user agents (e.g., one or more web browsers). In another example, processing a website may comprise interpreting (e.g., parsing) at least some of the website using one or more web user agents. A website may, for example, comprise a blog, a forum, and/or a social networking site. In one implementation, a website may comprise content provided by administrators and/or owners of the website, and may not comprise content provided by users of the website (e.g., by submitting a comment and/or post).

The policy creation component 202 may be configured to create one or more website profiles 206. The one or more profiles may be created based on the processing 204, and/or may indicate one or more types of content comprised in the website. A website profile may be created for respective web user agents. For example, a first profile may be created for a first web user agent based on a processing of the website by the first web user agent, a second profile may be created for a second web user agent based on a processing of the website by the second web user agent, and a third profile may be created for a third web user agent based on a processing of the website by the third web user agent. In another example, a website profile may be created for more than one web user agents. In the example, a fourth profile may be created based on a processing of the website by the first web user agent, a processing of the website by the second web user agent, and a processing of the website by the third web user agent.

The policy creation component 202 may further be configured to create one or more policies 208. The one or more policies may comprise one or more rules, and may be created based at least partially on one or more profiles. In one example, a policy may be created for respective web user agents. In the example, a first policy may be created for a first web user agent based on a first profile of the website corresponding to the first web user agent, a second policy may be created for a second web user agent based on a second profile of the website corresponding to the second web user agent, and a third policy may be created for a third web user agent based on a third profile of the website corresponding to the third web user agent. In another example, a policy may be created for more than one web user agents. In the example, a fourth policy may be created based on a first profile of the website corresponding to the first web user agent, a second profile of the website corresponding to the second web user agent, and a third profile of the website corresponding to the third web user agent. In a different example, one or more policies may also be based at least in part on input provided by an administrator and/or owner of a website, and/or an administrator and/or owner of a service configured to provide for web user agent based inspection.

The system 200 may comprise a code profiling component 210. The code profiling component 210 may be configured to receive code 212. In one example, the code may comprise content provided by a user of a blog, a forum, and/or a social networking site. In the example, the content may have been provided by the user by submitting a comment or a post.

The code profiling component 210 may be configured to process code 214. Processing code may comprise opening code using one or more web user agents (e.g., one or more web browsers). In another example, processing code may comprise interpreting (e.g., parsing) at least some of the code using one or more web user agents.

The code profiling component 210 may be configured to create one or more profiles 216. The one or more profiles may be created based on the processing 214, and/or may indicate one or more types of content comprised in received code. A profile may be created for respective web user agents. For example, a first profile may be created for a first web user agent based on a processing of received code by the first web user agent, a second profile may be created for a second web user agent based on a processing of received code by the second web user agent, and a third profile may be created for a third web user agent based on a processing of received code by the third web user agent. In another example, a profile may be created for more than one web user agents. In the example, a fourth profile may be created based on a processing of code by the first web user agent, a processing of code by the second web user agent, and a processing of code by the third web user agent.

The system 200 may comprise a code validation component 218. The code validation component 218 may be configured to receive one or more policies created by the policy creation component 202, and one or more code profiles created by the code profiling component 210. The code validation component may further be configured to evaluate 220 the one or more code profiles received from the code profiling component 210 based on one or more of the policies received from the policy creation component 202. In one example, a code profile (e.g., corresponding to content provided by a user of a blog, a forum, and/or a social networking site) may be compared to a policy. In the example, the policy may have been created for a web user agent. In another example, evaluation of the code profile based on the policy may comprise determining whether the code profile conflicts with one or more rules comprised in the policy. The code validation component 218 may make a determination 222 based on the evaluation 220.

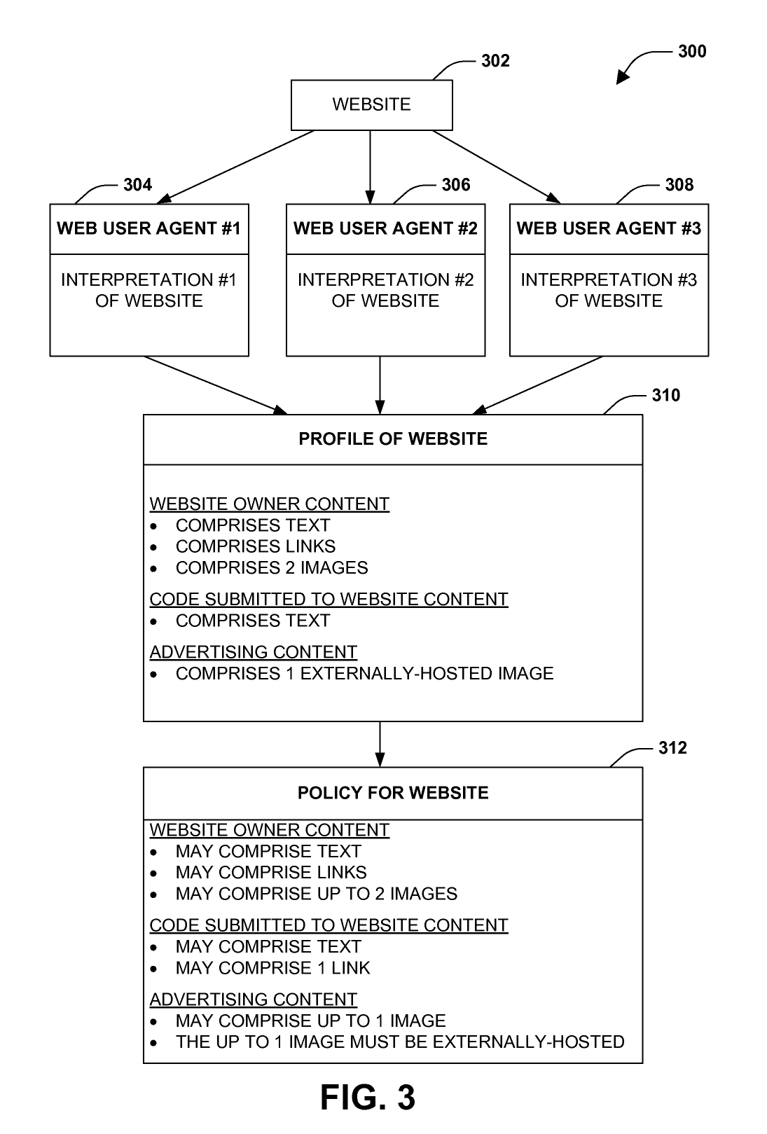

FIG. 3 illustrates an example of a method 300 for creating a profile and a policy for a website. At 302, there is a website. The website may, for example, comprise a blog, a forum, and/or a social networking site. In one example, the website may comprise content provided by administrators and/or owners of the website, and may not comprise content provided by users of the website (e.g., by submitting a comment and/or post). At 304, 306, and 308, the website may be processed (e.g., interpreted) by web user agent #1, web user agent #2, and web user agent #3, respectively.

At 310, a profile of the website may be created. The profile of the website may be based on the processing of the website by web user agent #1, web user agent #2, and web user agent #3, and may indicate one or more types of content comprised in the website. The profile of the website may indicate, for example, that the website comprises three parts. The website may comprise a first part comprising content provided by an owner of the website, a second part comprising content submitted to the website (e.g., by a user of the website), and a third part comprising advertising content. The profile may further indicate that the content provided by the owner of the website comprises text, one or more links, and/or two or more images. The profile may also indicate that the content submitted to the website (e.g., by a user of the website) comprises text, and that the advertising content comprises one or more images (e.g., that are externally hosted).

At 312, a policy for the website may be created. The policy may be based at least in part on the profile created for the website at 310. The policy may also be based at least in part on input provided by an administrator and/or owner of the website, and/or an administrator and/or owner of a service configured to provide for web user agent based inspection. The policy may, for example, comprise one or more rules, and may correspond to web user agent #1, web user agent #2, and web user agent #3. The policy may indicate that content provided by the website owner may comprise text, links, and up to two images. The policy may further indicate that content submitted to the website (e.g., by a user of the website) may comprise text and up to one link. The policy may also indicate that advertising content may comprise up to one image, and may require that the one image be externally hosted (e.g., by a server not associated with the website).

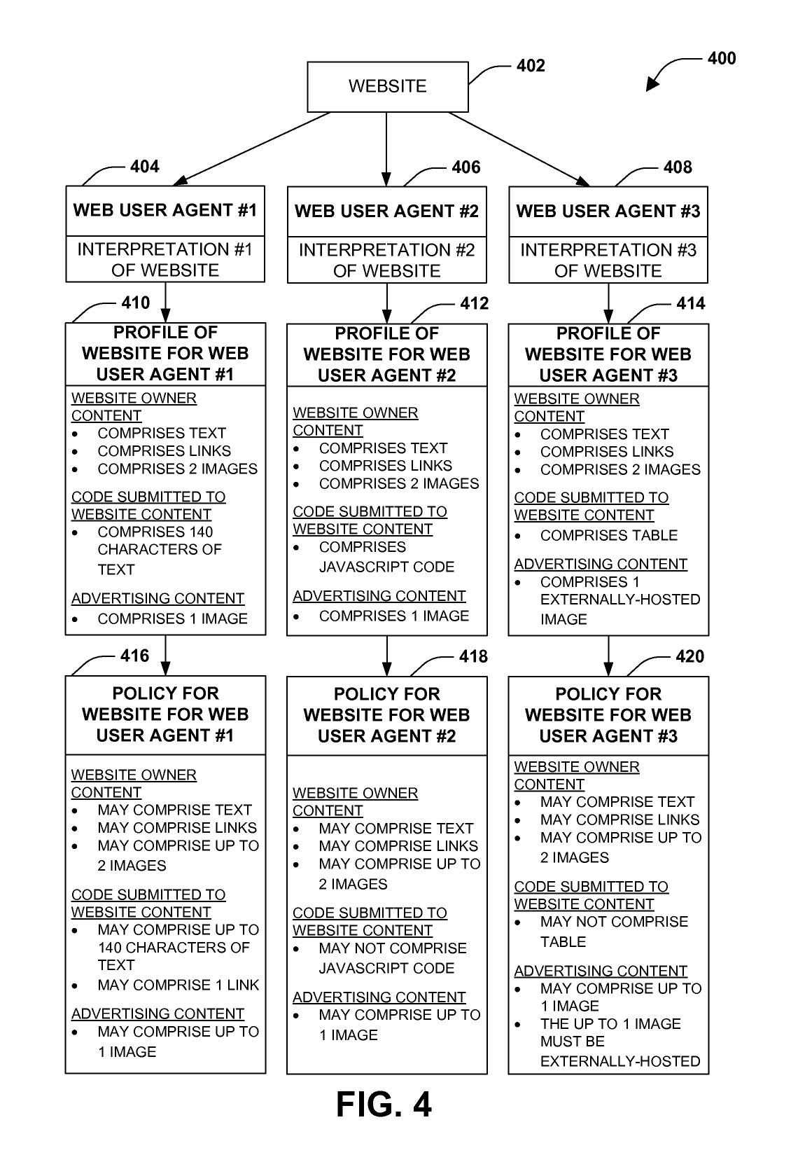

FIG. 4 illustrates an example of a method 400 for creating one or more profiles and one or more policies for a website. At 402, there is a website. The website may, for example, comprise a blog, a forum, and/or a social networking site. In one example, the website may comprise content provided by administrators and/or owners of the website, and may not comprise content provided by one or more users of the website (e.g., by submitting a comment and/or post). At 404, 406, and 408, the website may be processed (e.g., interpreted) by web user agent #1, web user agent #2, and web user agent #3, respectively.

At 410, 412, and 414, one or more profiles of the website may be created. A first profile may be created based on the processing by web user agent #1, a second profile may be created based on the processing by web user agent #2, and a third profile may be created based on the processing by web user agent #3. The profiles of the website may indicate one or more types of content comprised in the website (e.g., according to the interpretation of the respective web user agents). For example, the first profile based on web user agent #1 may indicate that a part of the website comprising content submitted to the website (e.g., by a user of the website) comprises a certain amount of text (e.g., 140 characters). The second profile based on web user agent #2 may further indicate that the content submitted to the website (e.g., by a user of the website) comprises code corresponding to a programming language (e.g., JavaScript). The third profile based on web user agent #3 may further indicate that the content submitted to the website (e.g., by a user of the website) comprises a table.

At 416, 418, and 420, one or more policies for the website may be created. A first policy corresponding to web user agent #1 may be created based on the first profile based on web user agent #1. A second policy corresponding to web user agent #2 may be created based on the second profile based on web user agent #2. A third policy corresponding to web user agent #3 may be created based on the third profile based on web user agent #3. One or more of the policies may also and/or alternatively be based at least in part on input provided by an administrator and/or owner of the website, and/or an administrator and/or owner of a service configured to provide for web user agent based inspection.

The respective policies may, for example, comprise one or more rules. The first policy may indicate that content submitted to the website (e.g., by a user of the website) may comprise up to 140 characters of text. The indication that content submitted to the website may comprise up to 140 characters of text may be determined based on the amount of text determined at 410 in the first profile for web user agent #1. In another example, the indication that content submitted to the website may comprise up to 140 characters of text may have been determined at least partially based on input provided by an administrator and/or owner of the website, and/or an administrator and/or owner of a service configured to provide for web user agent based inspection.

The second policy may indicate that content submitted to the website (e.g., by a user of the website) may not comprise code corresponding to a programming language (e.g., JavaScript). The indication that content submitted to the website may not comprise code corresponding to a programming language may be determined based on the reference to code corresponding to a programming language in the second profile for web user agent #2.

The third policy may indicate that content submitted to the website (e.g., by a user of the website) may not comprise a table. The indication that content submitted to the website may not comprise table may have been determined based on the reference to a table in the third profile for web user agent #2.

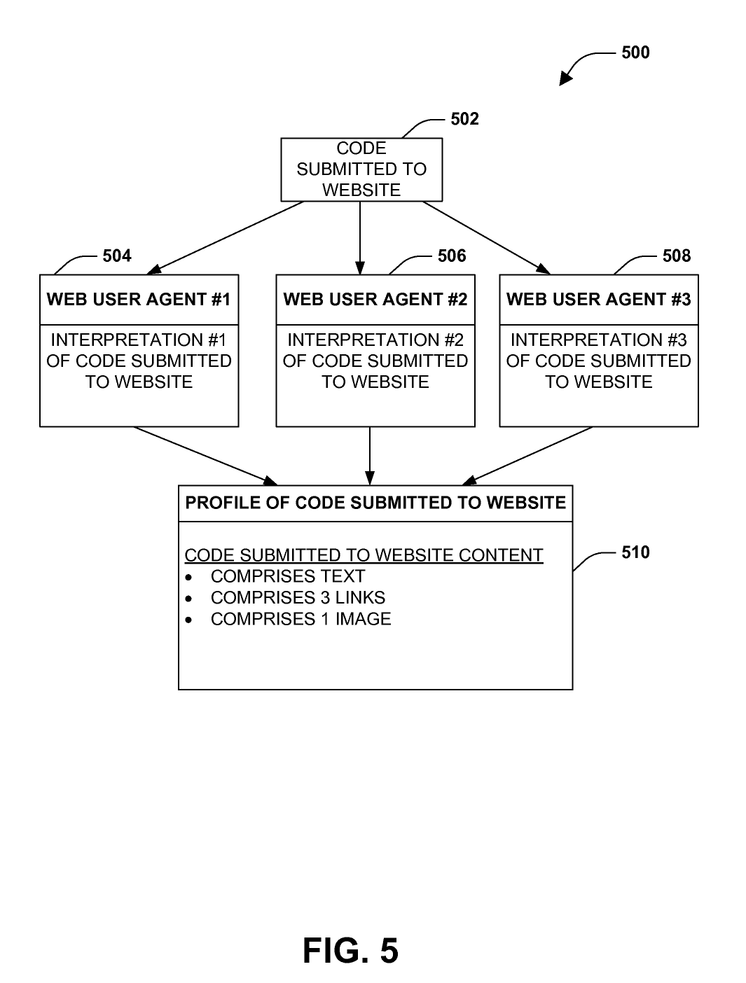

FIG. 5 illustrates an example of a method 500 for creating a profile of code submitted to a website. At 502, code may be submitted to a website. The website may, for example, comprise a blog, a forum, and/or a social networking site. In one example, the code may comprise content provided by a user of the website (e.g., by submitting a comment and/or post). At 504, 506, and 508, the website may be processed (e.g., interpreted) by web user agent #1, web user agent #2, and web user agent #3, respectively.

At 510, a profile of the code submitted to the website may be created. The profile of the code may be based on the processing of the website by web user agent #1, web user agent #2, and web user agent #3, and may indicate one or more types of content comprised in the code. The profile of the code may indicate, for example, that the code comprises text, three links, and one image.

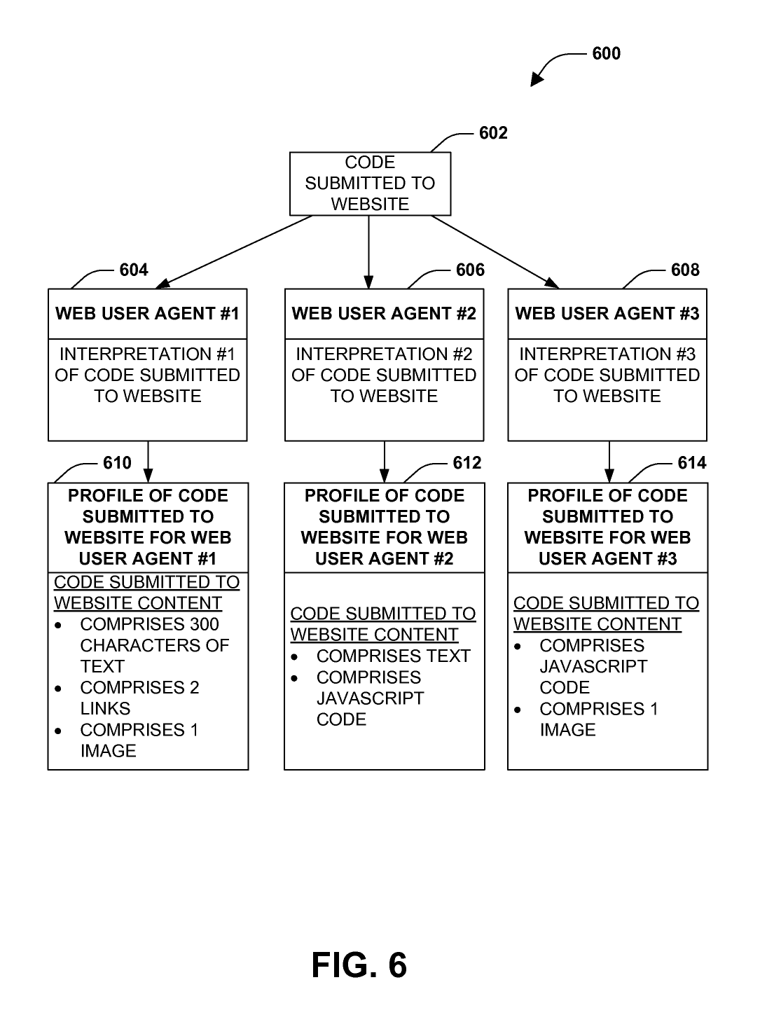

FIG. 6 illustrates an example of a method 600 for creating one or more profiles of code submitted to a website. At 602, code may be submitted to a website. The website may, for example, comprise a blog, a forum, and/or a social networking site. In one example, the code may comprise content provided by a user of the website (e.g., by submitting a comment and/or post). At 604, 606, and 608, the website may be processed (e.g., interpreted) by web user agent #1, web user agent #2, and web user agent #3, respectively.

At 610, 612, and 614, one or more profiles of the code submitted to the website may be created. A first profile may be created based on the processing by web user agent #1, a second profile may be created based on the processing by web user agent #2, and a third profile may be created based on the processing by web user agent #3. The profiles of the code may indicate one or more types of content comprised in the code. For example, the first profile based on web user agent #1 may indicate that the code comprises an amount of text (e.g., 300 characters), a number of links (e.g., two), and a number of images (e.g., one). The second profile based on web user agent #2 may further indicate that the code submitted to the website (e.g., by a user of the website) comprises text, and code corresponding to a programming language (e.g., JavaScript). The third profile based on web user agent #3 may further indicate that the code comprises a number of images (e.g., one) and code corresponding to a programming language (e.g., JavaScript).

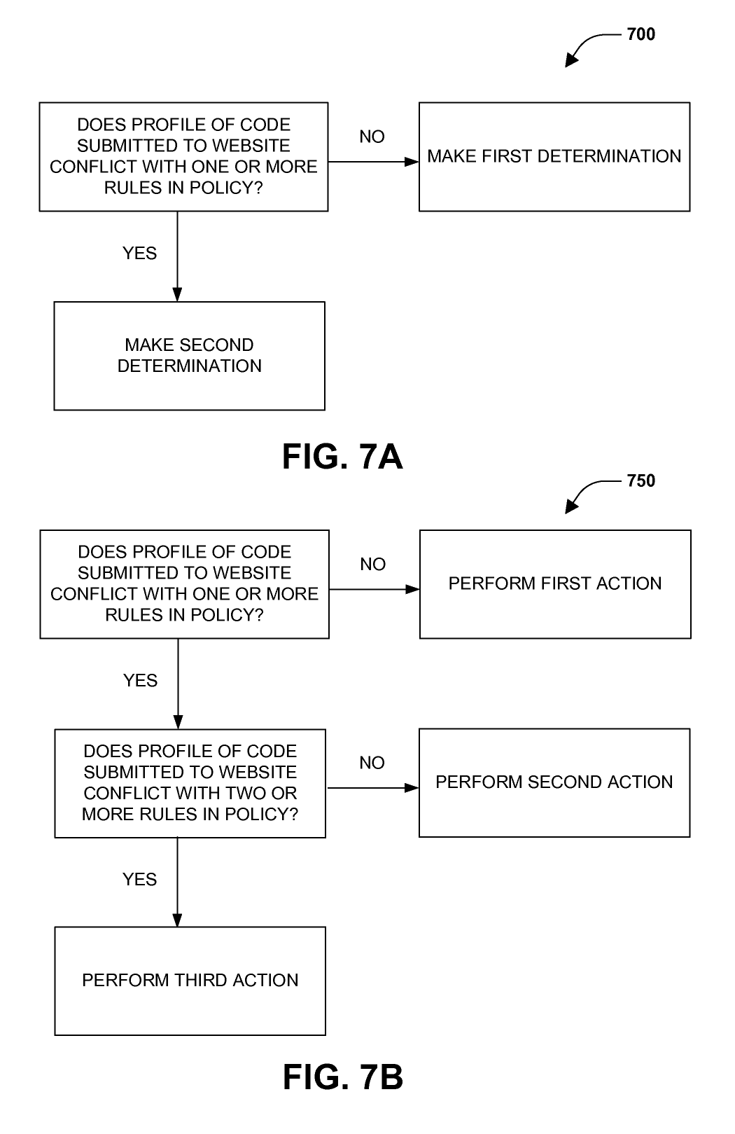

FIG. 7A illustrates an example of a method 700 for making a determination based on an evaluation of a profile (e.g., based on a policy). The profile may correspond to code submitted to a website. In one example, the code may have been submitted to the website by a user of the website. The website may, for example, comprise a blog, a forum, and/or a social networking site. In another example, an evaluation of the profile may be based on, for example, whether the profile conflicts with one or more rules comprised in a policy. The policy may, for example, correspond to a same web user agent as the profile. If a determination is made that the profile conflicts with one or more rules in the policy, a first determination may be made (e.g., to not provide code corresponding to the profile to a client). If a determination is made that the profile does not conflict with one or more rules in the policy, a second determination may be made (e.g., to provide code corresponding to the profile to a client).

FIG. 7B illustrates an example of a method 750 for making a determination based on an evaluation of a profile (e.g., based on a policy). The profile may correspond to code submitted to a website. In one example, the code may have been submitted to the website by a user of the website. The website may, for example, comprise a blog, a forum, and/or a social networking site. In another example, an evaluation of the profile may be based on, for example, whether the profile conflicts with one or more rules comprised in a policy. The policy may, for example, correspond to a same web user agent as the profile. If a determination is made that the profile does not conflict with one or more rules in the policy, a first action may be performed. The first action may comprise, for example, providing code corresponding to the profile to a client. If a determination is made that the profile does conflict with one or more rules in the policy, then a determination may be made as to whether the profile conflicts with two or more rules in the policy. If a determination is made that the profile does not conflict with two or more rules in the policy (e.g., but does conflict with one or more rules in the policy), then a second action may be performed. The second action may comprise, for example, providing code corresponding to the profile to server for further (e.g., automatic and/or manual) evaluation. If a determination is made that the profile does conflict with two or more rules in the policy, then a third action may be performed. The third action may comprise, for example, not providing code corresponding to the profile to the client.

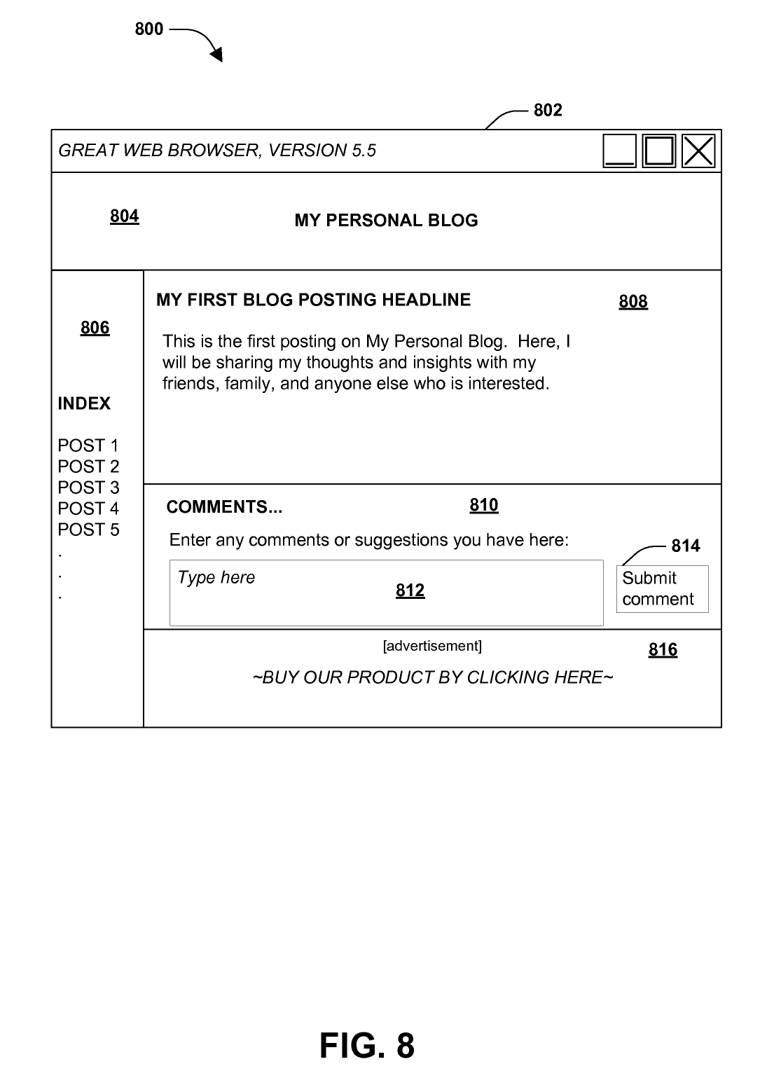

FIG. 8 illustrates an example 800 of a website. The website may be accessed using a web user agent 802 (e.g., a web browser), and may comprise a blog. The website may comprise a first area 804, which may comprise text and/or an image (e.g., indicating a title of the website), as well as a second area 806, which may comprise an index (e.g., of previous blog posts). The website may further comprise a third area 808, which may comprise content provided by an owner and/or administrator of the website. In one example, the content provided by an owner and/or administrator of the website may comprise a blog post. The website may comprise a fourth area 810, which may enable a user (e.g., a visitor of the website other than the owner and/or administrator of the website) to submit data to a server associated with the website. The submitted data may be comprised in the website (e.g., after web user agent based inspection of the submitted data). The fourth area 810 may, for example, comprise an area 812 for the user to provide input (e.g., text, one or more links, images, videos, etc.). The fourth area 810 may also comprise a button 814 (e.g., that enables the web user agent to provide the input to the server). The website may further comprise a fifth area 816, which may comprise advertising content. The advertising content may comprise text, one or more images, and/or one or more videos. In one example, the advertising content may at least partially be hosted by a server associated with the website. In another example, the advertising content may at least partially be hosted by an external server (e.g., that does not host the website).

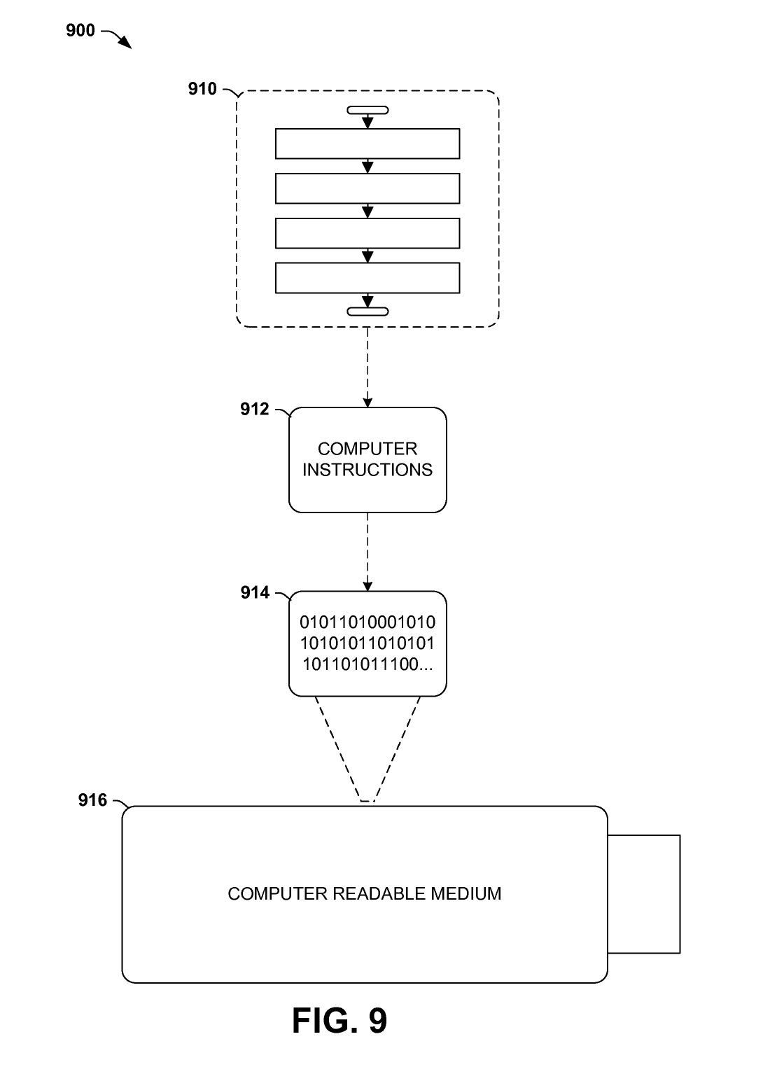

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 916 (e.g., a USB flash drive, a CD-R, a DVD-R, or a platter of a hard disk drive), on which is encoded computer-readable data 914. This computer-readable data 914 in turn comprises a set of computer instructions 912 configured to operate according to one or more of the principles set forth herein. In one such embodiment 900, the processor-executable computer instructions 912 may be configured to perform a method 910, such as at least some of the exemplary method 100 of FIG. 1 and/or at least some of exemplary method 600 of FIG. 6, for example. In another such embodiment, the processor-executable instructions 912 may be configured to implement a system, such as at least some of the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

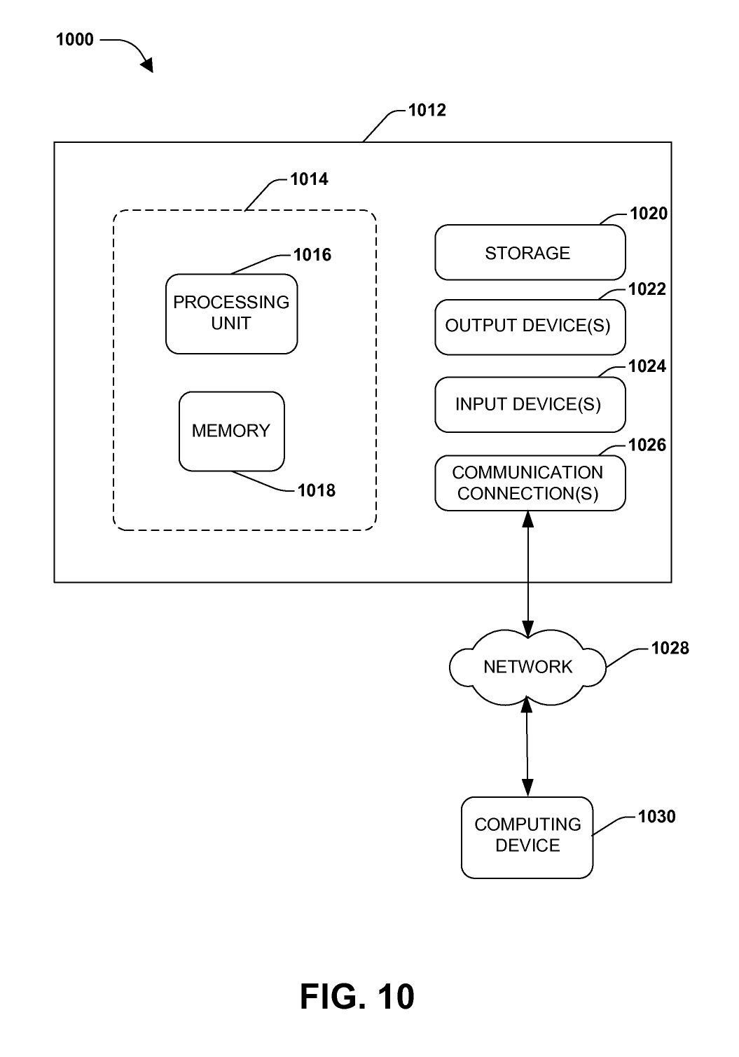

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like. It may be appreciated that one or more virtual computers may be used to implement at least some of the embodiments of the provisions set forth herein.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1000 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via a network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method comprising:
evaluating code based upon one or more policies using one or more web user agents to process the code; and
making a determination based upon the evaluating.

2. The method of claim 1, the code comprising content provided by a user.

3. The method of claim 1, at least some of the method performed by at least one of:
a server configured to receive the code; and
a user accessing a website associated with the server.

4. The method of claim 1, the evaluating comprising detecting at least one of:
a JavaScript element comprised in a list comprising one or more restricted elements;
a JavaScript element not comprised in a list comprising one or more allowed elements;
an IFrame tag;
a script tag;
text in a size at least one of:
greater than a maximum text size; and
smaller than a minimum text size;
an amount of text at least one of:
greater than a maximum text amount; and
less than a minimum text amount;
a reference to a location not comprised in a list comprising one or more allowed locations; and
a reference to a location comprised in a list comprising one or more restricted locations.

5. The method of claim 1, the evaluating comprising:
comparing the code to at least one of the one or more policies.

6. The method of claim 1, the evaluating comprising:
determining if a rendering of the code by at least one of the one or more web user agents conflicts with a rule associated with at least one of the one or more policies.

7. The method of claim 6, the making a determination comprising:
if a determination is made that the rendering of the code by one or more of the web user agents conflicts with the rule, receiving instructions from an outside decision system.

8. The method of claim 1, at least one of the web user agents comprising a web browser.

9. A computer readable medium comprising instructions that when executed by a processing unit, perform a method comprising:
receiving code comprising content provided by a user;
processing the code using one or more web user agents;
creating one or more profiles based upon the processing;
evaluating at least one of the one or more profiles based upon one or more policies; and
making a determination based upon the evaluating.

10. The computer readable medium of claim 9, at least some of the method performed by at least one of:
a server configured to receive the content from the user; and
a second user accessing a website associated with the server.

11. The computer readable medium of claim 9, the evaluating comprising detecting at least one of:
a JavaScript element comprised in a list comprising one or more restricted elements;
a JavaScript element not comprised in a list comprising one or more allowed elements;
an IFrame tag;
a script tag;
text in a size at least one of:
greater than a maximum text size; and
smaller than a minimum text size;
an amount of text at least one of:
greater than a maximum text amount; and
less than a minimum text amount;
a reference to a location not comprised in a list comprising one or more allowed locations; and
a reference to a location comprised in a list comprising one or more restricted locations.

12. The computer readable medium of claim 9, at least one of the one or more policies created based upon at least one of:
input received from at least one of an owner and an administrator of an original website; and
one or more original website code profiles created in response to at least one of a creation and a modification of the original website,
the original website associated with a server configured to receive the content from the user.

13. The computer readable medium of claim 12, the one or more original website code profiles created based upon a processing of the original website using one or more web user agents.

14. A system comprising:
a code profiling component configured to:
receive website code associated with an original website, the website code comprising content provided by a user;
process the website code using one or more web user agents; and
create one or more website code profiles based upon the processing; and
a code validation component configured to:
evaluate at least one of the one or more website code profiles based upon one or more website code policies; and
make a determination based upon the evaluating.

15. The system of claim 14, at least one of the web user agents comprising a web browser.

16. The system of claim 14, at least some of the system implemented via a server configured to receive the content from the user.

17. The system of claim 14, at least some of the system implemented via a second user accessing a website associated with a server configured to receive the content from the user.

18. The system of claim 14, comprising:
a policy creation component configured to:
process the original website using at least some of the one or more web user agents;
create one or more original website code profiles based upon the processing of the original website; and
create the one or more website code policies based upon at least one of the one or more original website code profiles.

19. The system of claim 14,
the receiving website code comprising:
receiving a first website code associated with the original website and corresponding to a first web user agent; and
receiving a second website code associated with the original website and corresponding to a second web user agent, the processing the website code comprising:
processing the first website code with the first web user agent; and
processing the second website code with the second web user agent.

20. The system of claim 14, the creating one or more website code profiles comprising detecting at least one of:
an existence of a script, a count of the script, and a size of text; and
a form, a size, and content of at least one of a Document Object Model tree and a JavaScript tree.
